(19) United States
(12) Patent Application Publication
(10) Pub. No.: US 2008/0123660 A1
(43) Pub. Date: May 29, 2008

(54) METHOD AND APPARATUS FOR PROVIDING DIFFERENTIATED QUALITY OF SERVICE FOR PACKETS IN A PARTICULAR FLOW

(75) Inventors: Mohammed Sammour, Montreal (CA); Arty Chandra, Manhasset Hills, NY (US); Catherine M. Livet, Montreal (CA); John S. Chen, Downingtown, PA (US); Jin Wang, Central Islip, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/836,554

(22) Filed: Aug. 9, 2007

Related U.S. Application Data
(60) Provisional application No. 60/821,905, filed on Aug. 9, 2006.
(60) Provisional application No. 60/840,817, filed on Aug. 29, 2006.

(51) Int. Cl. H04L 12/56

(52) U.S. Cl. 370/395.21

(57) ABSTRACT

Each of a plurality of packets in a particular flow is classified into one of a plurality of quality of service (QoS) classes based on information about each packet. Each packet is then adaptively processed based on the QoS class for each packet. The classification may be performed based on media information included in a session description protocol (SDP) messaging. The classification may also be performed based on a real-time transmit protocol (RTP) payload, an RTP header, a transmission control protocol (TCP) header, a user datagram protocol (UDP) header, and an Internet protocol (IP) header. The packets may be transmitted using multiple system architecture evolution (SAE) radio bearers each of which is used to deliver differentiated QoS requirements. The packets may be mapped to eigen-modes based on the QoS class of each packet such that a packet requiring a higher level of QoS is mapped to a stronger eigen-mode.

### CROSS REFERENCE TO RELATED APPLICATION

This application claims the benefit of U.S. provisional application Nos. 60/821,905 filed Aug. 9, 2006 and 60/840,817 filed Aug. 29, 2006, which are incorporated by reference as if fully set forth.

### FIELD OF INVENTION

The present invention is related to wireless communication systems. More particularly, the present invention is related to a method and apparatus for providing differentiated quality of service (QoS) for packets in a particular flow.

### BACKGROUND

Third generation partnership project (3GPP) has initiated a long term evolution (LTE) project to bring new technology, new network architecture and configuration, and new applications and services to the wireless cellular network in order to provide improved spectral efficiency, reduced latency, faster user experiences and richer applications and services with less cost. FIG. 1 shows system architecture evolution (SAE) bearer service architecture in a 3GPP LTE network. An end-to-end service 112 is provided between a user equipment (UE) 102 and a peer entity 108. An SAE bearer service 114 is provided between the UE 102 and an access gateway (aGW) 106. An SAE radio bearer service 116 is provided between the UE 102 and an evolved Node-B (eNode-B) 104. An SAE access bearer service 118 is provided between the eNode-B 104 and the aGW 106.

In general, the SAE bearer service 114 includes all aspects to enable the provision of a contracted QoS. These aspects include, but not limited to, control signaling, user plane (U-plane) transport, and QoS management functionality. The SAE bearer service 114 typically provides QoS-wise aggregation of Internet protocol (IP) end-to-end-service flows, IP header compression and provision of related information to the UE, U-plane encryption and provision of related information to the UE, provision of mapping and multiplexing information to the UE, and provision of accepted QoS information to the UE. If prioritized treatment of end-to-end-service signaling packets is required, an additional SAE bearer service may be added to the default IP service.

The SAE radio bearer service 116 provides transport of the SAE bearer service data units between the eNode-B and the UE according to the required QoS and linking of the SAE radio bearer service to the respective SAE bearer service. The SAE access bearer service 118 provides transport of the SAE bearer service data units between the aGW and the eNode-B according to the required QoS, provision of aggregate QoS description of the SAE bearer service 114 towards the eNode-B, and linking of the SAE access bearer service 118 to the respective SAE bearer service 114.

In accordance with one proposal for the LTE, there is a one-to-one mapping between an SAE radio bearer 116 and an SAE access bearer 118, and an SAE bearer 114, (i.e., the corresponding SAE radio bearer 116 and SAE access bearer 118), is the level of granularity for QoS control. That is, service data flows (SDFs) mapped to the same SAE bearer receive the same treatment, (e.g., scheduling principle). An SDF is an aggregate set of packet flows.

FIG. 2 shows establishment of SAE bearers between a UE 202 and a policy and charging enforcement function (PCEF) 206 in accordance with the above proposal. Each SAE bearer 211a, 211b comprises one SAE radio bearer 212a, 212b and one SAE access bearer 214a, 214b. An uplink packet filter (ULPF) 222a, 222b in the UE 202 binds an uplink SDF 226 to an SAE bearer in the uplink direction, and a downlink packet filter (DLPF) 224a, 224b in the PCEF 206 binds a downlink SDF 228 to an SAE bearer in the downlink direction. The SAE radio bearer identity (ID) and the SAE access bearer ID are linked at the eNode-B 204. Since the SAE bearer is the level of granularity for QoS control, in order to provide different QoS to multiple SDFs, multiple separate SAE bearers are required. As an example, FIG. 2 shows establishment of two separate SAE bearers 211a, 211b.

In accordance with other proposals for the LTE system, the one-to-one mapping constraint between SAE access bearer and SAE radio bearer is removed, and multiple SAE radio bearers may be mapped to one SAE access bearer.

If an SAE radio bearer is one-to-one mapped to an SAE access bearer, an SAE radio bearer and an SAE bearer are the level of granularity for QoS control. If multiple SAE radio bearers may be mapped to one SAE access bearer, the SAE radio bearer, not the SAE bearer, is the level of granularity for QoS control. The SAE radio bearer (or the SAE bearer) will provide the same QoS treatment for all the packets on the SAE radio bearer (or the SAE bearer). For example, one of the current 3GPP QoS attributes is a service data unit (SDU) error ratio. The same SDU error rate is applied for the whole SAE radio bearer (or SAE bearer).

In the current universal mobile telecommunication system (UMTS), the QoS parameters or attributes that are specified for a radio bearer and a packet data protocol (PDP) context QoS information element include traffic class, traffic handling priority, transfer delay, residual bit error rate (BER), SDU error ratio, and the like. These parameters apply equally to all packets on the radio bearer, radio access bearer (RAB) or PDP context in the current UMTS.

Certain applications, (such as video), contain different types of packets in the same SDF. For example, moving picture expert group (MPEG) video streams contain three (3) types of frames: intra-frames (I), predictive frames (P), and bidirectional frames (B), as shown in FIG. 3. An I-frame is a self-contained image and not based on any other frames in the video stream. I-frames are the only frames that can be decoded all by themselves. A P-frame is based on a previous I-frame or P-frame, and only the differences from the previous frame are encoded. A B-frame is based on both the previous I- or P-frames and coming I- or P-frames. In MPEG video frames, I packets are more important than P or B frames. Therefore, a packet including I frame need higher error protection and a lower packet loss rate than a packet including P or B frames. Such per-packet differentiated QoS treatment cannot be efficiently provided in the current 3GPP or LTE architecture.

Differentiated service (DiffServ) architecture has been proposed, which is pertinent to the Internet. In DiffServ architecture, packets are marked by setting a “drop precedence” field to define relative priorities between packets in regards to being dropped by an Internet node, (e.g., a router), during congestion. The 3GPP architecture supports DiffServ edge functions in a gateway general packet radio services (GPRS) support node (GGSN).

However, the 3GPP does not support or define if or how radio access functions can support and achieve different treatment for packets with different drop precedence values that belong to the same DiffServ flow. Moreover, the current 3GPP LTE architecture does not support the DiffServ model's per-packet drop precedence, (e.g., differentiated loss), and it does not define if or how the different LTE nodes and functions can adapt their behavior and operation based on different per-packet drop precedence settings. Therefore, it would be desirable to provide a method and apparatus for providing differentiated QoS for packets in the same flow.

### SUMMARY

The present invention is related to a method and apparatus for providing differentiated QoS for packets in a particular flow. Each of a plurality of packets in a particular flow is classified into one of a plurality of QoS classes based on information about each of the packets. Each of the packets is then adaptively processed based on the QoS class for each packet. The QoS classes may be defined in terms of a packet loss target, an error protection target, a latency target, maximum transmission delay, a minimum data rate, a maximum data rate, jitter requirements, and bandwidth requirements. The classification may be performed based on media information included in a session description protocol (SDP) messaging. For example, moving picture expert group (MPEG) packets, (i.e., intra (I) frames, predictive (P) frames and bidirectional (B) frames), are classified differently for differentiated QoS. The classification may be performed based on a real-time transmit protocol (RTP) payload, an RTP header, a transmission control protocol (TCP) header, a user datagram protocol (UDP) header, and an Internet protocol (IP) header. The packets may be transmitted using multiple SAE radio bearers each of which is used to deliver differentiated QoS requirements, or alternatively using a single SAE radio bearer. After performing a channel decomposition to determine eigen-modes, the packets may be mapped to eigen-modes based on the QoS class of each packet such that a packet requiring a higher level of QoS is mapped to a stronger eigen-mode.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows conventional SAE bearer service architecture in a 3GPP LTE network;

FIG. 2 shows establishment of SAE bearers between a UE and a PCEF in a conventional 3GPP LTE network;

FIG. 3 shows a sequence of MPEG frames;

FIG. 4 is a block diagram of an apparatus for supporting differentiated QoS requirements for packets in the same service data flow in accordance with the present invention;

FIG. 5 shows an MPEG video specific header included in the RTP payload;

FIG. 6 shows an RTP header; and

FIG. 7 shows eigen-values plotted across the subcarriers.

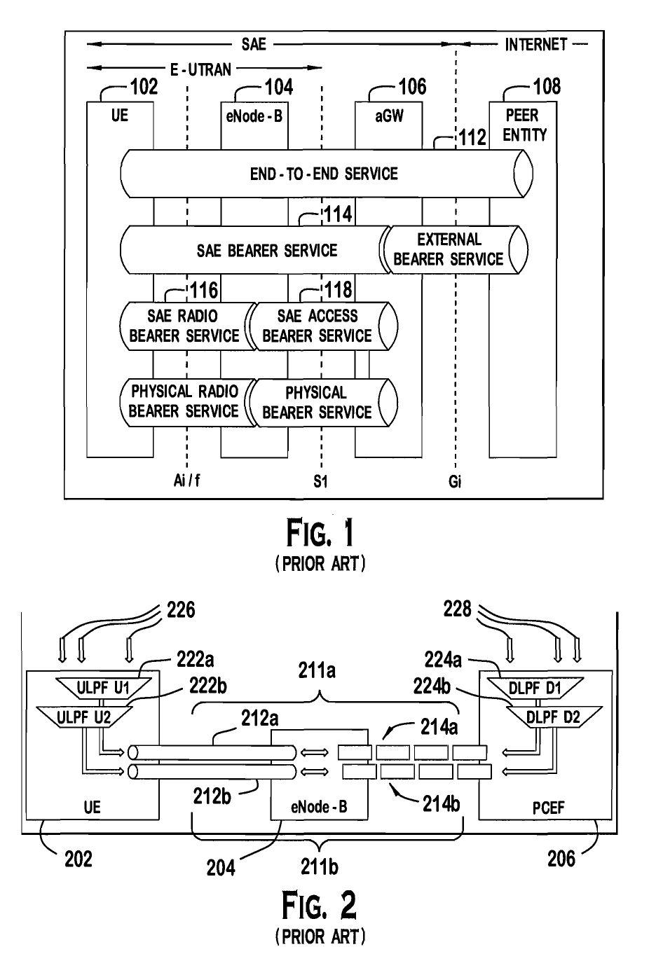

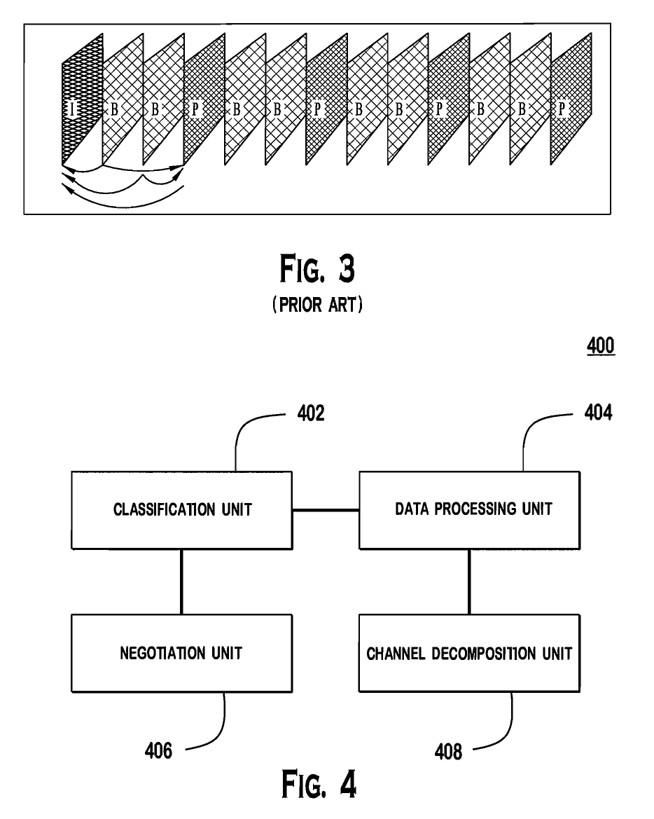

### DETAILED DESCRIPTION OF THE PREFERRED EMBODIMENTS

When referred to hereafter, the terminology “wireless transmit/receive unit (WTRU)” includes but is not limited to a UE, a mobile station, a fixed or mobile subscriber unit, a pager, a cellular telephone, a personal digital assistant (PDA), a computer, or any other type of user device capable of operating in a wireless environment. When referred to hereafter, the terminology “eNode-B” includes but is not limited to a base station, a Node-B, a site controller, an access point (AP), or any other type of interfacing device capable of operating in a wireless environment.

In accordance with the present invention, differentiated QoS treatment is provided for each packet in a particular flow. The “flow” may be defined at any level or layer, such as an application flow, an IP flow, an SDF, an SAE bearer, a radio bearer, or any flow. The flow may be an end-to-end flow, an intermediate flow, or an aggregate flow of smaller flows. The term “packet” refers to any granularity of data, including an SDU, a protocol data unit (PDU), or a segment of an SDU or PDU. It should be noted that the term “SAE” may be replaced with a different term. For example, the term “SAE” may be replaced with “evolved packet system” (EPS), and the terms “SAE bearer” or “SAE radio bearer” may be replaced with “EPS bearer” or “EPS radio bearer”, respectively, or any other relevant terms.

FIG. 4 is a block diagram of an apparatus 400 for supporting differentiated QoS treatment for packets in a particular flow in accordance with the present invention. The apparatus 400 includes a classification unit 402 and a data processing unit 404. The apparatus 400 may optionally include a negotiation unit 406 and a channel decomposition unit 408. The apparatus 400 may reside in a WTRU for uplink traffic. The apparatus 400 may reside in any node in a network for downlink traffic, (e.g., an aGW, a mobility management entity (MME), a user plane entity (UPE), a PCEF, or the like). In the network side, at least one of the classification unit 402, the data processing unit 404, the negotiation unit 406, and the channel decomposition unit 408 may reside in a different entity in the network.

The classification unit 402 receives a plurality of packets in a flow and classifies, (i.e., differentiates), each of the packets into one of a plurality of QoS classes based on information about each of the packets for differentiated QoS treatments. The classified QoS class is indicated for each packet. The classification unit 402 may output a tag, a label, a mark, or a service primitive, (hereinafter collectively “tag”). The QoS class of each packet is indicated within, or along with, each packet by the tag.

The data processing unit 404, (e.g., a radio link control (RLC) unit, a medium access control (MAC) unit and a physical layer (PHY) unit), adapts their processing based on the tag of the packet that is being processed in order to provide differentiated QoS for the packets with different tags within a particular flow. For example, maximum HARQ transmission or delay, transport format combination (TFC) selection, error protection, (e.g., error detection/correction coding), packet multiplexing, and the like may be adaptively adjusted for each packet in accordance with the tag of each packet.

For the adaptive processing, the negotiation unit 406 may communicate the significance of each QoS parameters and requirements and its corresponding tag in advance, (e.g., between a WTRU and a network, or between network entities). The communication may be performed during bearer establishment, (i.e., SAE radio bearer and SAE bearer establishment).

Each QoS class is defined with different QoS criteria. The QoS criteria may be a packet loss target, an error protection target, a latency target, maximum transmission delay, minimum and/or maximum data rate, jitter requirements, bandwidth requirements, and the like. The QoS criteria may include specific parameters, such as a modulation and coding scheme (MCS), TFC selection parameters, maximum HARQ transmissions or delay, maximum automatic repeat request (ARQ) transmissions or delay, a relative or absolute priority, or the like.

For example, the classification unit 402 may classify packets into four (4) different QoS classes based on the packet loss target. If a flow has packets # 1, 2, 3, 4, 5, 6, 7, and assuming that packet 2 and 6 has the most stringent packet loss target, (i.e., the lowest packet loss rate), followed by packets 1 and 3, followed by packet 4, followed by packets 5 and 7. The classification unit 402 classifies packets 1-7 with four different QoS classes 1 through 4, respectively, in accordance with the packet loss target of the packets.

The granularity of differentiated QoS may be a fraction of a packet. The classification unit 402 may further classify segments of a single packet in terms of the QoS criteria, and different QoS may be provided to each segment of a single packet. In such case, the classification unit 402 may output information regarding the boundary of the differentiated segments of the given packet for different classification.

The classification unit 402 may classify packets based on the media information included in a session description protocol (SDP) part of session initiation protocol (SIP) messaging. Within an IP multimedia subsystem (IMS), session establishment and modification involves an end-to-end message exchange using an SIP and an SDP with negotiation of media attributes, (e.g., codecs), as defined in 3GPP TS 24.229 and 3GPP TS 24.228, for example. The SDP text messages include session name and purpose, time that the session is active, media information, information to receive the media, (e.g., address), and the like. The media information includes the type of the media, (i.e., video, audio, and the like), the transport protocol, (e.g., RTP, UDP, IP, H.320, and the like), and the format of the media, (e.g., H.261 video, MPEG video, and the like).

For example, if the media information indicates that the session will use an MPEG codec, the classification unit 402 classifies the packets based on MPEG frame type as well as any other information. The MPEG packets have specific formats that indicate what type of information is contained therein. Preferably, the classification unit 402 examines each MPEG packet, (e.g., packets in an MPEG elementary stream or other MPEG streams), and extracts the packet type information, (i.e., whether the packet includes an I-, P- or B-frame), and classifies the packets into different QoS classes based on the packet type information. For example, a packet including an I-frame may be assigned a lower target packet loss rate than that of a P-frame or a B-frame. Additionally, MPEG audio packets may use different QoS requirements than those used for MPEG video packets.

A basic component in MPEG is an elementary stream. A program, (e.g., a television program, or a digital versatile disk (DVD) track), contains a combination of elementary streams, (typically, one for video, one or more for audio, control data, subtitles, and the like). The various forms of elementary streams include digital control data, digital audio (sampled and compressed), digital video (sampled and compressed), and digital data (synchronous, or asynchronous). The classification unit 402 may classify the packets belonging to different MPEG elementary streams, (e.g., a video stream and an audio stream), into different QoS classes.

The classification unit 402 may use other granularities to differentiate MPEG data. For example, the classification unit 402 may further classify data in a single MPEG packet based on whether the data is a motion vector or residual image data.

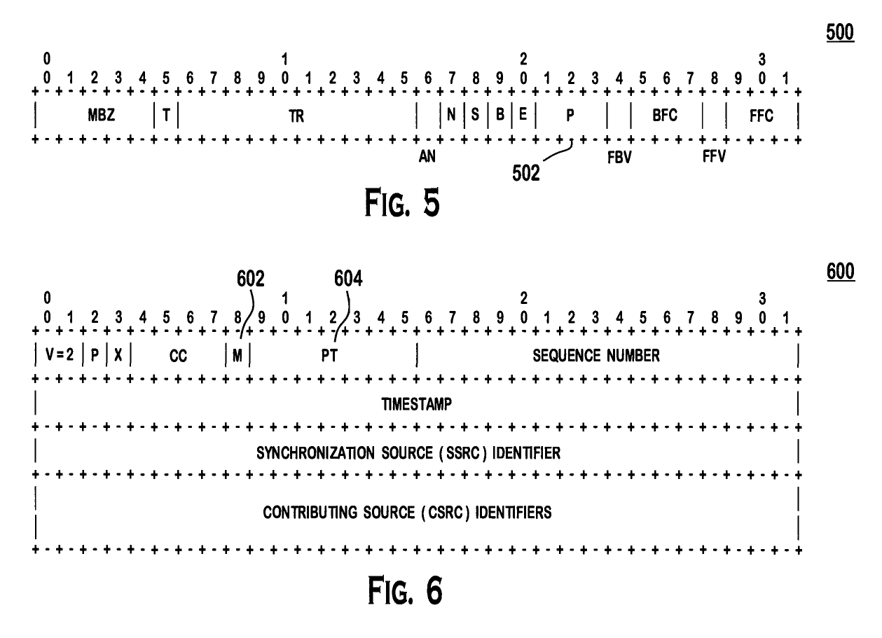

The classification unit 402 may classify packets based on information in an RTP payload. FIG. 5 shows an MPEG video specific header 500 included in the RTP payload. Some MPEG RTP payload formats specify the MPEG frame type of the packet. For example, RFC 2250 defines a picture type field (P) 502 within the video-specific header 500 of the RTP payload, which can indicate whether an I-, P- or B-frame is contained within the packet.

The classification unit 402 examines the RTP payload, (e.g., a video-specific header 500 in the RTP payload), and extracts the picture type field 502 (or an equivalent field). The picture type field 502 indicates whether an I-, P-, or B-frame is contained in the packet. The classification unit 402 then classifies the packets into different QoS classes based on the picture type field. Any fields of the RTP payload's specific headers may be used for classification, such as fields in the MPEG video-specific header, MPEG-2 video-specific header, or MPEG audio-specific header, and the like.

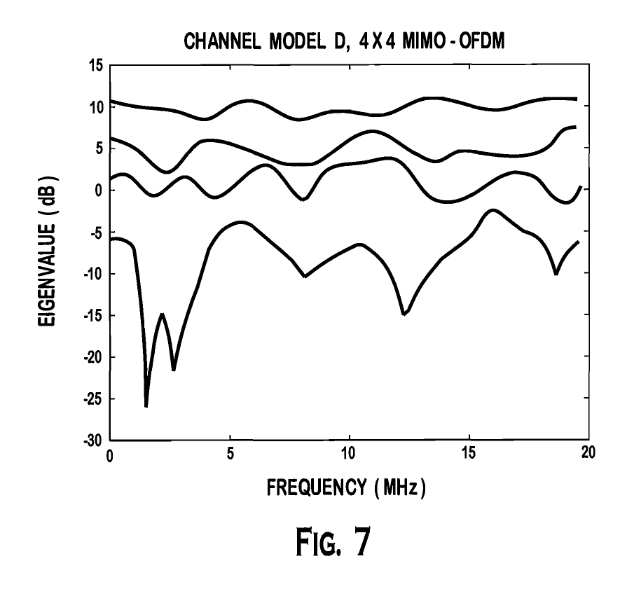

The classification unit 402 may classify packets based on information in an RTP header. FIG. 6 shows an RTP header 600. The RTP header 500 includes fields such as a marker bit (M) 602 and a payload type (PT) field 604. The market bit 602 indicates significant events, (e.g., frame boundaries), to be marked in the packet stream, which typically need different QoS, (e.g., higher error protection or a lower loss rate). The payload type field 604 identifies the format of the RTP payload. Distinct payload types are assigned for video elementary streams and audio elementary streams. For example, payload type 14 represents MPEG audio, which denotes MPEG-1 or MPEG-2 audio encapsulated as elementary streams, while payload type 32 represents MPEG video, which designates the use of MPEG-1 and MPEG-2 video encoding elementary streams. The classification unit 402 extracts the marker bit 602, the payload type field 604, and/or any other fields in the RTP header 600 and classifies packets into the proper QoS classes based on that.

The classification unit 402 may classify packets based on information from the transport and/or IP layers. The classification unit 402 examines a TCP header, a UDP header, and/or an IP header and classifies the packets based on the information in the TCP/UDP/IP headers. For example, the classification may be performed based on the TCP or UDP port numbers, IP destination address and/or IP source address, the IP protocol field indicating the next level protocol, (e.g., TCP, UDP), or the IPv4 type of service (TOS) octet and the IPv6 traffic class octet which are re-defined as the DiffServ field that includes the DiffServ code point (DSCP) field. For example, the classification unit 402 may differentiate packets going to, and/or coming from, different hosts based on the IP destination and/or source addresses.

Classification of the packets may be based on other types of information in the TCP header, the UDP header and/or the IP header. For example, the packet size is usually affected by the type of information contained within the packet. The size of I-frames is usually larger than that of B- or P-frames in MPEG packets, since I-frames convey a full image. The correlation analysis of the properties of the information inside the MPEG packets may be different for different packets. The classification unit 402 may use the packet size information or the correlation analysis to classify the packets into different QoS classes. If there is a specific pattern of the encoder, (e.g., a specific sequence of frame types that the encoder outputs), such frame pattern may be made known to the classification unit 402, and the classification unit 402 may use the frame pattern information to classify the packets into different QoS classes. The classification based on packet size, correlation analysis, or frame pattern information is useful in the absence of other classification methods, (e.g., if classification cannot be performed based on upper layer information, such as RTP or IP).

The classification unit 402 may classify packets based on translating or mapping conventional classification information. For example, in DiffServ, IP packets are marked with one of three (3) possible drop precedence values. The drop precedence assignment is based on whether the traffic bandwidth conforms to certain limits. In case of congestion, the drop precedence of a packet determines the relative importance of the packet. A congested node tries to protect packets with a lower drop precedence value from being lost by preferably discarding packets with a higher drop precedence value. In accordance with the present invention, the classification unit 402 maps the DiffServ drop precedence value indicated in the DSCP field of the packet into a corresponding QoS class based on pre-defined rules. This classification is particularly useful if the marking of the drop precedence is performed based on the types of application packets, (e.g., when different video frame types, (I-, P- or B-frames), have their underlying IP packets marked with different drop precedence values).

The classification may be performed by at any layer. Since robust header compression (ROHC) generally examines the RTP/UDP/IP headers and/or the TCP/IP headers, the classification may be performed at a layer that performs header compression. The classification may also be performed at an RLC or MAC layer. If the per-packet tag does not exist in the packet due to a lack of prior classification, the classification may be locally performed based on any of the methods described above, and the behavior of the data processing units are adapted accordingly. For example, the packet size information may be examined at the MAC or RLC layer to classify the packets and the data processing unit adapts the processing based on the classification. The classification unit 402 may spoof (examine) the upper-layer information for classification and perform the adaptive functions based on the classification. The classification method described hereinbefore may be used independently or in combination.

Once a packet has been classified, the classification unit 402 outputs the classified QoS class for each classified packet. The classification result is communicated within, or along with, the packet. A tag, (or a label, a mark, or the like), may be attached to each packet to indicate the classified QoS class for the packet. The tag may be a specific tag used to indicate a specific packet loss rate or packet error rate target, or a general QoS tag to convey one or more QoS requirements or parameters. Alternatively, the classification unit 402 may signal the classification result as a service primitive if the classification unit 402 and the data processing unit that will adapt its behavior based on the QoS classification exist in the same node, (e.g., in the WTRU for uplink traffic case).

In accordance with an LTE proposal, a label, a guaranteed bit rate (GBR), a maximum bit rate (MBR), and possibly an allocation and retention priority are communicated between an eNode-B and an MME/UPE across the S1 interface. These parameters are associated with an SAE bearer and are provided to the eNode-B at SAE bearer establishment and modification. The label identifies a “traffic handling behavior” required from the eNode-B. The label is just a pointer that points to a QoS realization in the eNode-B. The label is not indicated in each packet, but rather the label is simply a single identifier of a QoS profile with many QoS attributes. The label is used for more efficient signaling, (i.e., sending only the label, not the QoS attributes, in the signaling procedures). In the current LTE architecture, all packets within the same flow are assigned the same label. In accordance with the present invention, in order to achieve different QoS support for different packets within the same flow or for packets that belong to different flows, different labels corresponding to different QoS requirements, (e.g., packet loss ratio or the error rate), may be used for each packet.

In order to increase the efficiency of the wireless medium, the tags may not be transmitted over the air. The eNode-B or the WTRU may strip the tag before transmitting the packet over the air. Alternatively, the tag may remain in the packet.

The per-packet tagging may be performed at any layer. In the network side, the S1 interface framing and encapsulation protocol, (e.g., general packet radio services (GPRS) tunneling protocol (GTP)), between the eNode-B and the aGW may include a field to support the QoS tag. Alternatively, the per-packet tag may be included in a packet data convergence protocol (PDCP) layer by including the tag in the PDCP header. In this case, the PDCP header may be made of two parts, a transmittable part and a droppable part. The droppable part of the header includes the tag and only the transmittable part is transmitted over the air. Once the eNode-B receives the PDCP packet from the aGW, the eNode-B strips off the droppable part and transmits only the transmittable part over the air. Alternatively, the per-packet tag may be performed at the RLC, MAC, or PHY layers. The RLC, MAC or PHY layers may have their own tag that is derived from the PDCP-level tag or the S1 tunneling protocol tag. For example, an upper layer assigns tag 1 to a packet and sends the packet with tag 1 to a lower layer. The lower layer generates another packet and assigns the generated packet with another tag, tag 2.

Alternatively, the differentiated service (DS) or DSCP field of the IP packet may be utilized for the per-packet tagging. For example, the drop precedence field in the IP packet may be used as the per-packet tag. In this case, the classification unit 402 may override such IP packet field based on the result of its classification. Alternatively, a QoS field(s), (such as a loss requirement field, a maximum number of retransmissions field, a target error rate field, or the like), may be added to the packet in order to explicitly indicate the parameters or QoS attributes to be used.

The data processing unit 404 in the WTRU and/or in the network adapts their behavior depending on the per-packet QoS tag in order to deliver differentiated QoS for each packet with a different tag within the same flow. The following description may be applied to the single radio bearer case or to the multiple radio bearers case.

RLC functions, (such as retransmissions and automatic repeat request (ARQ)), may be adapted on a packet-by-packet basis based on the required QoS that the packet tag indicates. For example, the maximum number of retransmissions may be higher for a packet whose tag requires a lower packet loss or a lower error rate. Segmentation and concatenation functions may be adapted based on the packet tag such that packets with similar QoS tag are concatenated together for example.

MAC functions, (such as HARQ retransmission, HARQ process selection, and the like), may be adapted on a packet-by-packet basis based on the required QoS that the packet tag indicates. For example, the maximum number of HARQ retransmissions may be higher for a packet whose tag requires a lower packet loss rate or a lower error rate. The redundancy versions (RV) of retransmissions may be selected to be more robust for a packet whose tag requires a lower packet loss rate or a lower error rate. For example, packets may be sent via different HARQ processes, (i.e., HARQ instances), that have different parameter setup depending on the packet tags.

MAC or PHY functions, (such as packet multiplexing), may be adapted based on the required QoS that the packet tag indicates. Multiplexing rules are signaled to define if, what, and how packets with different tags may be multiplexed together in the same transmission time interval (TTI). For example, the rule may allow packets with different tags to be multiplexed with each other in the same TTI, and may specify that the most stringent QoS requirement should be applied to the resulting multiplexed packet.

Other MAC or PHY functions, such as TFC selection, multiple-input multiple-output (MIMO) stream selection, (i.e., selection of different antenna beams in MIMO, subset of antennas, or beamforming), modulation and coding, transmit power, radio resource blocks in frequency and time domain (time/frequency distribution and number of subcarriers), or any function that can affect the QoS may be adapted based on the required QoS that the tag indicates.

When spatial multiplexing is supported at the PHY layer and multiple dimensional HARQ is used at the MAC layer, TFC selection procedure is able to map packets with different QoS tags to different HARQ processes that are configured with different parameters and attributes to guarantee different QoS requirements. When logical channels or MAC flows requiring different QoS need to be transmitted in a common TTI, these flows may be mapped to HARQ processes associated with physical resources with channel quality that more closely matches the QoS requirement of the packets to be transmitted. The TFC selection may operate either dynamically or semi-statically based on the system requirement and configuration.

When multiple SAE radio bearers are utilized, all those multiple SAE radio bearers may be associated with a single SAE bearer, or each of the multiple SAE radio bearers may be associated with a different SAE bearer. The key aspect is that different SAE radio bearers are utilized to deliver the differentiated QoS.

In the first case that all of multiple SAE radio bearers are associated with a signal SAE bearer, the eNode-B and the WTRU split or map the packets it receives from a single SAE bearer into multiple SAE radio bearers based on the QoS label or the per-packet tag that indicates different QoS requirements. In the second case that each of the multiple SAE radio bearers is associated with a different SAE bearer, there is no need to split the SAE bearer packets because of the one-to-one mapping between an SAE bearer and an SAE radio bearer.

In accordance with the present invention, upper layer sequence numbering, (e.g., PDCP sequence numbering or common sequence numbering), may be instantiated and maintained separately for each of the SAE radio bearers. In the current LTE architecture, upper layer sequence numbering is maintained per SAE bearer, and if packets from an SAE bearer are allowed to be mapped onto multiple SAE radio bearers, then having a single upper layer sequence number used across multiple SAE radio bearers can create limitations or problems for QoS, (e.g., reordering delay problems). By adding the ability to utilize and assign a separate upper layer sequence numbers for each of the SAE radio bearers, potential QoS limitations can be overcome. However, the ability to share the same upper layer sequence number among multiple SAE radio bearers may still be sufficient or adequate for some applications, such as in the case when packets on different SAE radio bearers belong to the same application flows and are sent to and received from the same hosts.

In order to offer the most flexibility in LTE systems, in accordance with the present invention, additional or extended signaling is performed when setting up an SAE bearer and/or corresponding SAE radio bearers to indicate which SAE radio bearers will be sharing the same upper layer sequence number and which SAE radio bearers will utilize a unique (un-shared) upper layer sequence number.

Conventionally, there is a one-to-one mapping between a radio bearer and a logical channel. If such one-to-one mapping restriction is removed, another alternative to achieve differentiated QoS may be via splitting the packets on multiple logical channels.

The negotiation unit 406 communicates the significance of each packet QoS class and its corresponding tag, preferably during bearer establishment, (e.g., radio bearer and SAE bearer establishment), in order to know how to provide per-packet QoS differentiation. For example, if four (4) tags of unequal QoS requirements are supported, the involved nodes need to be signaled so that they know how to handle each of those tags. Additionally, configuration and/or signaling is needed to define multiplexing rules for packets with different tags in order to specify, for example, what kind of MAC multiplexing is allowed, (i.e., which packet tags may be combined with each other and how the combined packet should be treated).

Any non-access stratum (NAS), access stratum (AS), RRC or MAC signals, or any LTE procedures may be extended to include support for the differentiated QoS requirements. For example, multiple packet loss/error rates and their associated tags may be indicated, instead of indicating only one packet loss/error rate as in the conventional systems.

Any of the IP bearer establishment procedures including, but not limited to, request/report resources message, request radio bearer message, radio bearer establishment or re-establishment messages, radio bearer setup message, radio bearer reconfiguration message, physical channel reconfiguration message, SAE bearer establishment or re-establishment message, SAE access bearer establishment or re-establishment message, RAB assignment request message, RAB modify request message, relocation request message, PDP context activation/re-activation procedures, attach or re-attach procedures, radio resource request or resource allocation messages, scheduling information message, buffer size message, and the like, may be extended to indicate their status for one or more packet QoS classes and their corresponding tags. For example, instead of indicating one SDU error ratio (or residual bit error rate (BER)) for the bearer, multiple SDU error ratios may be indicated together with their corresponding tags.

Alternatively, the specific function parameters, (e.g., RLC, HARQ or MAC parameters), may be signaled for each of the different packet QoS classes. Additionally, for flexible support of upper layer sequence numbering, (e.g., PDCP sequence number), such messages or procedures may be extended to indicate whether the multiple radio bearers belonging to the same SAE bearer should be assigned a sequence number from the same (shared) upper layer sequence number instance, or whether certain radio bearers may have their own upper layer sequence number instance that is un-shared with other radio bearers. Each radio bearer may preferably have its own upper layer sequence number instance, (e.g., PDCP SN).

If the IP DS or DSCP field is used to indicate the packet QoS tag, the above signals may be extended, or new signals may be added, to indicate the packet QoS tag for each of the different DSCP drop precedence values.

Audio, video, voice over IP (VoIP), signal packet flows and messages, and To/From packet flow addresses all need to be differentiated from one another. A video application, (e.g., conference or MPEG), has an audio content as well. The packets are classified, and audio packets will have different loss requirements (tags) than video packets. Separate radio bearers may be used for video and audio. Alternatively, the same radio bearer may be used for video and audio, but the packet tags will adapt the data processing functions to provide different QoS for audio and video.

Avideo application, (e.g., conference or MPEG), has many types of frames or packets, (e.g., I-, P-, B-frame). The video packets are classified and assigned different QoS tags. Separate radio bearers may be used for different types of video frames. Alternatively, the same radio bearer may be used for the video frames, but the packet QoS tags adapt the data processing functions to provide different QoS for the different packet types.

A VoIP application, (e.g., AMR), has many types or classes of bits, (e.g., A-, B-, C-type bits). The packets containing different bits are classified differently and assigned different QoS tags. The packets are then segmented to create separate packets that contain bits that have different QoS requirements. Separate radio bearers may be used for different types of VoIP frames. Alternatively, the same radio bearer is used for the different types of VoIP frames, but the packet QoS tags will adapt the data processing functions to provide different QoS for the different packet types.

In accordance with the preset invention, control packets are also provided with differentiated QoS. The signaling or control packets include RRC messages, NAS message, AS messages, handover commands, robust header compression (ROHC)/compression context information, (e.g., context updates), RLC status PDUs, or move receiver window (MRW) PDUs, or the like. Each control packet has a different degree of QoS requirements depending on the impact of loss. For example, certain control protocol messages may need to arrive in a timely fashion and hence need high error protection (low packet loss rate). In accordance with the present invention, the control packets are classified and assigned different QoS tags. Separate radio bearers may be used for different control packets. Alternatively, the same radio bearer may be used for different types of control packets, but the packet QoS tags will adapt the processing functions to provide different QoS for the different control packet types.

Operators would like to be able to prioritize packets going to, or coming from, a particular content provider, (e.g., web site). For example, even though the user has the same applications, (e.g., web browsing), the application's packet may receive different treatment depending on the content provider. In accordance with the present invention, the application packets are classified, (e.g., based on IP addresses and/or port information), and assigned different QoS tags). Separate radio bearers may be used for application packets with different QoS tags. Alternatively, the same radio bearer may be used for the application packets with different QoS tags, but the processing functions may be adapted to provide different QoS for the application packets having different QoS tags.

A method for supporting differentiated QoS for packets over the air interface is described hererinafter. One of the techniques that is being proposed in LTE is eigen-beamforming. Eigen beamforming performs eigen decomposition of the channel matrix to determine eigen modes. This may be done open loop or closed loop. A transmitter transmits data over the eigen modes. The eigen decomposition may be performed by using singular value decomposition (SVD), or equivalents.

In multiple-input multiple-output (MIMO) orthogonal frequency division multiplexing (OFDM), a transmitter and a receiver includes nT transmit antenna and nR receive antennas, respectively. A channel transfer matrix H between nT transmit antennas and nR receive antennas is as follows:

$$\begin{matrix}H = [ \begin{matrix}{h}_{11} & {h}_{21} & … & {h}_{1 , nT} \\ {h}_{21} & {h}_{22} & … & {h}_{2 , nT} \\ & & ⋰ & ⋮ \\ {h}_{nR , 1} & {h}_{nR , 2} & … & {h}_{nR , nT}\end{matrix} ] & Equation ( 1 ) \\ H = {UDV}^{H} ; & Equation ( 2 )\end{matrix}$$

where U and V are unitary matrices and D is a diagonal matrix. UεC_{nR×nR} and VεC_{nT×nT}. U are eigenvectors of H^{H}H, V are eigenvectors of HH^{H} and D is a diagonal matrix of singular values of H (square roots of eigen-values of H^{H}H). For transmit symbol vector s, the transmit preceding is performed as follows:

x=Vs. Equation (3)

The received signal becomes as follows:

y=HVs+n; Equation (4)

where n is the noise introduced in the channel. The receiver completes the decomposition by using a matched filter as follows:

V^{H}H^{H}=V^{H}VD^{H}U^{H}=D^{H}U^{H}. Equation (5)

After normalizing for channel gain for eigen-beams, the estimate of the transmit symbols s becomes as follows:

$$\begin{matrix}\hat{s} = α {D}^{H} {U}^{H} HVs + η \\ = s + η .\end{matrix} \qquad Equation ( 6 )$$

Hence, s is detected without having to perform successive interference cancellation or minimum mean square error (MMSE) type detector. D^{H}D is a diagonal matrix that is formed by eigen-values of H across the diagonal. Therefore, the normalization factor α=D⁻².

Data is sent across the eigen-modes defined by the channel matrix. As shown in FIG. 7, when the eigen-values are plot across the subcarriers, the stronger eigen-values (eigen-modes) are relatively frequency non-selective across the band and afford better quality of service and higher error protection. The weaker eigen-values (eigen-modes) vary more across the band and they are suited for carrying data with less stringent error protection requirements.

In accordance with the present invention, I-frames are mapped to the stronger eigen-modes for transmission and the B and P frames are mapped to the remaining eigen-modes. The present invention is not limited to MPEG, but may be applied to any application where different part of data requires different QoS.

Differentiated QoS, (e.g., unequal error protection), may be provided through spatial frequency scheduling, and this may be combined with eigen-beamforming, or more conventional open and closed loop space time coding techniques. Frames which require higher QoS are sent on those frequency carriers which exhibit a strong dominant eigen-mode, a stronger channel rank, or higher signal-to-interference and noise ratio (SINR) as commanded from the receiver through channel quality indicator (CQI) and/or channel state information (CSI) feedback.

In addition, combined with the above techniques, modulation and coding scheme (MCS) adaptation may be performed. An MCS adaptation may be used to further support of differentiated QoS, for example in MPEG, by allocating I frames to lower order modulation carriers, (e.g., quadrature phase shift keying (QPSK)), or those carriers/eigen-modes with lower coding rates. When multiple video streams are sent simultaneously, it is desirable to group I frames of all streams on the medium that has stronger protection as described above.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for providing differentiated quality of service (QoS) on a per-packet basis for frames in a particular flow in a wireless communication system, the method comprising:
receiving a plurality of packets in a flow;
classifying each of the packets into one of a plurality of QoS classes based on information about each of the packets;
indicating a classified QoS class for each of the packets; and
processing each of the packets adaptively based on the indicated QoS class for each packet.

2. The method of claim 1 wherein the QoS classes are defined in terms at least one of a packet loss target, an error protection target, a latency target, maximum transmission delay, a minimum data rate, a maximum data rate, jitter requirements, and bandwidth requirements.

3. The method of claim 1 wherein the QoS classes are defined in terms at least one of a modulation and coding scheme (MCS), transport format combination (TFC) selection parameters, maximum hybrid automatic repeat request (HARQ) transmissions and delay, maximum automatic repeat request (ARQ) transmissions and delay, and a priority.

4. The method of claim 1 further comprising:
segmenting each of the packets into a plurality of segments, each segment having a different QoS requirement; and
classifying each segment into one of the QoS classes based on information about each segment, wherein the segments are processed adaptively based on QoS class assigned to each segment.

5. The method of claim 1 wherein the classification is based on media information included in a session description protocol (SDP) part of session initiation protocol (SIP) messaging.

6. The method of claim 1 wherein the packets are moving picture expert group (MPEG) packets, each of the packets including one of an intra (I) frame, a predictive (P) frame and a bidirectional (B) frame, and the packets including I frame, P frame and B frame are classified differently by examining a format of each MPEG packet.

7. The method of claim 6 wherein MPEG audio packets and MPEG video packets are classified differently.

8. The method of claim 1 wherein the classification is performed based on information in a real-time transmit protocol (RTP) payload.

9. The method of claim 8 wherein the classification is performed based on a picture type field in the RTP payload.

10. The method of claim 8 wherein the classification is performed based on at least one of a moving picture expert group (MPEG) video-specific header, an MPEG-2 video-specific header, and an MPEG audio-specific header included in the RTP payload.

11. The method of claim 1 wherein the classification is performed based on information in a real-time transmit protocol (RTP) header.

12. The method of claim 11 wherein the classification is performed based on at least one of a marker bit and a payload type field in the RTP header.

13. The method of claim 1 wherein the classification is performed based on information in at least one of a transmission control protocol (TCP) header, a user datagram protocol (UDP) header, and an Internet protocol (IP) header.

14. The method of claim 13 wherein the classification is performed based on at least one of a TCP port number, a UDP port number, an IP destination address, an IP source address, an IP protocol field indicating the next level protocol, an IPv4 type of service (TOS) octet, an IPv6 traffic class octet, a packet size, a correlation analysis of properties of information in the packets, and specific frame pattern information.

15. The method of claim 1 wherein the classification is performed by mapping a drop precedence value of a packet to one of the QoS classes.

16. The method of claim 1 wherein the classified QoS class is indicated by adding a tag in each packet.

17. The method of claim 16 wherein the tag is removed before transmitting the packet over an air.

18. The method of claim 16 wherein the tag is transmitted over an air.

19. The method of claim 16 the tag is included in an S1 tunneling protocol level between a Node-B and an access gateway.

20. The method of claim 16 wherein the tag is included in a packet data convergence protocol (PDCP) header.

21. The method of claim 20 wherein the PDCP header includes a transmittable part and a droppable part, and the tag is included in the droppable part, which is not transmitted over the air.

22. The method of claim 16 wherein the tag is included in a differentiated service code point (DSCP) field in an IP packet.

23. The method of claim 16 wherein the tag is included in a QoS field added to the packet in order to explicitly indicate QoS parameters.

24. The method of claim 1 wherein the classified QoS class is indicated by attaching a label indicating a QoS profile with a plurality of QoS attributes for each packet.

25. The method of claim 1 wherein the classified QoS class is indicated by signaling a service primitive.

26. The method of claim 1 wherein at least one of radio link control (RLC) functions, medium access control (MAC) functions, and physical layer functions are adapted on a packet-by-packet basis based on the indicated QoS class of each packet.

27. The method of claim 26 wherein hybrid automatic repeat request (HARQ) retransmission and HARQ process selection for each packet are adapted based on the indicated QoS class of each packet.

28. The method of claim 26 wherein the packets are multiplexed based on the indicated QoS class of each packet.

29. The method of claim 26 wherein at least one of transport format combination (TFC) selection, multiple-input multiple-output (MIMO) stream selection, modulation and coding scheme (MCS) selection, transmit power, radio resource blocks in frequency and time domain for each packet is adapted based on the indicated QoS of each packet.

30. The method of claim 1 wherein the packets are transmitted using multiple system architecture evolution (SAE) radio bearers, each SAE radio bearer being used to deliver differentiated QoS requirements.

31. The method of claim 30 wherein multiple SAE radio bearers are associated with a single SAE bearer.

32. The method of claim 31 wherein the packets are divided into multiple streams based on the indicated QoS class of the packets.

33. The method of claim 30 wherein each of the SAE radio bearers is associated with a different SAE bearer.

34. The method of claim 33 wherein upper layer sequence numbering is instantiated and maintained separately for each of a plurality of SAE radio bearers.

35. The method of claim 34 wherein additional signaling is performed when setting up an SAE bearer and corresponding SAE radio bearers to indicate which SAE radio bearers are sharing the same upper layer sequence number and which SAE radio bearers are not sharing the same upper layer sequence number.

36. The method of claim 1 further comprising:
communicating association information of each QoS class and its corresponding QoS parameters and requirements for adaptive processing of the packets.

37. The method of claim 36 wherein communication of the association information occurs during bearer establishment.

38. The method of claim 36 wherein at least one of non-access stratum (NAS) signaling, access stratum (AS) signaling, radio resource control (RRC) signaling and medium access control (MAC) signaling is used for the communication of the association information.

39. The method of claim 36 wherein a message exchanged during IP bearer establishment is used for the communication of the association information.

40. The method of claim 1 wherein separate radio bearers are used for video packets and audio packets.

41. The method of claim 1 wherein the packets are control packets.

42. The method of claim 1 further comprising:
performing a channel decomposition to determine eigen-modes; and
mapping packets to eigen-modes for transmission over an air based on the QoS class of each packet such that a packet requiring a higher level of QoS is mapped to a stronger eigen-mode.

43. The method of claim 1 further comprising:
mapping a packet requiring a higher level of QoS to a frequency carrier which exhibits a strong eigen-mode, a stronger channel rank, and a higher signal-to-interference and noise ratio (SINR).

44. The method of claim 1 further comprising:
mapping a packet requiring a higher level of QoS to a lower order modulation and a lower coding rate.

45. An apparatus for providing differentiated quality of service (QoS) on a per-packet basis for packets in a particular flow in a wireless communication system, the apparatus comprising:
a classification unit configured to classify each of a plurality of packets in the particular flow into one of a plurality of QoS classes based on information about each packet and indicate a classified QoS class for each of the packets; and
a data processing unit configured to process each of the packets adaptively based on the indicated QoS class for each packet.

46. The apparatus of claim 45 wherein the QoS classes are defined in terms at least one of a packet loss target, an error protection target, a latency target, maximum transmission delay, a minimum data rate, a maximum data rate, jitter requirements, and bandwidth requirements.

47. The apparatus of claim 45 wherein the QoS classes are defined in terms at least one of a modulation and coding scheme (MCS), transport format combination (TFC) selection parameters, maximum hybrid automatic repeat request (HARQ) transmissions and delay, maximum automatic repeat request (ARQ) transmissions and delay, and a priority.

48. The apparatus of claim 45 wherein the classification unit is configured to classify segments of each of the packets into one of the QoS classes based on information about each segment so that the segments are processed adaptively by the data processing unit based on QoS class assigned to each segment.

49. The apparatus of claim 45 wherein the classification is based on media information included in a session description protocol (SDP) part of session initiation protocol (SIP) messaging.

50. The apparatus of claim 45 wherein the packets are moving picture expert group (MPEG) packets, each of the packets including one of an intra (I) frame, a predictive (P) frame and a bidirectional (B) frame, and the packets including I frame, P frame and B frame are classified differently by examining a format of each MPEG packet.

51. The apparatus of claim 50 wherein MPEG audio packets and MPEG video packets are classified differently.

52. The apparatus of claim 45 wherein the classification is performed based on information in a real-time transmit protocol (RTP) payload.

53. The apparatus of claim 52 wherein the classification is performed based on a picture type field in the RTP payload.

54. The apparatus of claim 52 wherein the classification is performed based on at least one of a moving picture expert group (MPEG) video-specific header, an MPEG-2 video-specific header, and an MPEG audio-specific header included in the RTP payload.

55. The apparatus of claim 45 wherein the classification is performed based on information in a real-time transmit protocol (RTP) header.

56. The apparatus of claim 55 wherein the classification is performed based on at least one of a marker bit and a payload type field in the RTP header.

57. The apparatus of claim 45 wherein the classification is performed based on information in at least one of a transmission control protocol (TCP) header, a user datagram protocol (UDP) header, and an Internet protocol (IP) header.

58. The apparatus of claim 57 wherein the classification is performed based on at least one of a TCP port number, a UDP port number, an IP destination address, an IP source address, an IP protocol field indicating the next level protocol, an IPv4 type of service (TOS) octet, an IPv6 traffic class octet, a packet size, a correlation analysis of properties of information in the packets, and specific frame pattern information.

59. The apparatus of claim 45 wherein the classification is performed by mapping a drop precedence value of a packet to one of the QoS classes.

60. The apparatus of claim 45 wherein the classified QoS class is indicated by adding a tag in each packet.

61. The apparatus of claim 60 wherein the tag is removed before transmitting the packet over an air.

62. The apparatus of claim 60 wherein the tag is transmitted over an air.

63. The apparatus of claim 60 the tag is included in an S1 tunneling protocol level between a Node-B and an access gateway.

64. The apparatus of claim 60 wherein the tag is included in a packet data convergence protocol (PDCP) header.

65. The apparatus of claim 64 wherein the PDCP header includes a transmittable part and a droppable part, and the tag is included in the droppable part, which is not transmitted over the air.

66. The apparatus of claim 60 wherein the tag is included in a differentiated service code point (DSCP) field in an IP packet.

67. The apparatus of claim 60 wherein the tag is included in a QoS field added to the packet in order to explicitly indicate QoS parameters.

68. The apparatus of claim 45 wherein the classified QoS class is indicated by attaching a label indicating a QoS profile with a plurality of QoS attributes for each packet.

69. The apparatus of claim 45 wherein the classified QoS class is indicated by signaling a service primitive.

70. The apparatus of claim 45 wherein the data processing unit includes at least one of radio link control (RLC) function, medium access control (MAC) function, and physical layer function that is adapted on a packet-by-packet basis based on the indicated QoS class of each packet.

71. The apparatus of claim 70 wherein hybrid automatic repeat request (HARQ) retransmission and HARQ process selection for each packet are adapted based on the indicated QoS class of each packet.

72. The apparatus of claim 70 wherein the packets are multiplexed based on the indicated QoS class of each packet.

73. The apparatus of claim 70 wherein at least one of transport format combination (TFC) selection, multiple-input multiple-output (MIMO) stream selection, modulation and coding scheme (MCS) selection, transmit power, radio resource blocks in frequency and time domain for each packet is adapted based on the indicated QoS of each packet.

74. The apparatus of claim 45 wherein the packets are transmitted using multiple system architecture evolution (SAE) radio bearers, each SAE radio bearer being used to deliver differentiated QoS requirements.

75. The apparatus of claim 74 wherein multiple SAE radio bearers are associated with a single SAE bearer.

76. The apparatus of claim 75 wherein the packets are divided into multiple streams based on the indicated QoS class of the packets.

77. The apparatus of claim 74 wherein each of the SAE radio bearers is associated with a different SAE bearer.

78. The apparatus of claim 77 wherein upper layer sequence numbering is instantiated and maintained separately for each of a plurality of SAE radio bearers.

79. The apparatus of claim 78 wherein additional signaling is performed when setting up an SAE bearer and corresponding SAE radio bearers to indicate which SAE radio bearers are sharing the same upper layer sequence number and which SAE radio bearers are not sharing the same upper layer sequence number.

80. The apparatus of claim 45 further comprising:
a negotiation unit for communicating association information of each QoS class and its corresponding QoS parameters and requirements for adaptive processing of the packets.

81. The apparatus of claim 80 wherein communication of the association information occurs during bearer establishment.

82. The apparatus of claim 80 wherein at least one of non-access stratum (NAS) signaling, access stratum (AS) signaling, radio resource control (RRC) signaling and medium access control (MAC) signaling is used for the communication of the association information.

83. The apparatus of claim 80 wherein a message exchanged during IP bearer establishment is used for the communication of the association information.

84. The apparatus of claim 45 wherein separate radio bearers are used for video packets and audio packets.

85. The apparatus of claim 45 wherein the packets are control packets.

86. The apparatus of claim 45 further comprising:
a channel decomposition unit for performing a channel matrix decomposition to determine eigen-modes, wherein the data processing unit maps the packets to eigen-modes for transmission over an air based on the QoS class of each packet such that a packet requiring a higher level of QoS is mapped to a stronger eigen-mode.

87. The apparatus of claim 45 wherein the data processing unit is configured to perform spatial frequency scheduling such that a packet requiring a higher level of QoS is mapped to a frequency carrier which exhibits a strong eigen-mode, a stronger channel rank, and a higher signal-to-interference and noise ratio (SINR).

88. The apparatus of claim 45 wherein the data processing unit is further configured to perform modulation and coding scheme (MCS) adaptation such that a packet requiring a higher level of QoS is mapped to a lower order modulation and a lower coding rate.
